(19) United States
(12) Patent Application Publication
(10) Pub. No.: US 2012/0045275 A1
(43) Pub. Date: Feb. 23, 2012

(54) Rail channel connector and arrangement with such connector

(75) Inventor: Gerd Vollmer, Sundern (DE)

(73) Assignee: SIGN-WARE GMBH & CO. KG, Sundern (DE)

(21) Appl. No.: 13/213,870

(22) Filed: Aug. 19, 2011

(30) Foreign Application Priority Data
Aug. 19, 2010 (DE) 20 2010 008 312.5

(51) Int. Cl. F16B 21/02

(52) U.S. Cl. 403/348

(57) ABSTRACT

A rail channel connector 4 has a connector 18 with a helical headpiece 5. The headpiece 5 is configured to engage into an undercut channel 2 of a rail 1 and for introducing the headpiece 5 into the undercut of the channel 2 through the channel opening 3 which runs the longitudinal length of the rail 1. The rail channel connector 4 comprises means for attaching an item onto same. Further a locking element with at least one locking bar 15, 15.1 is provided for engaging into the channel 2 in order to secure the headpiece 5 when it has been inserted into the undercut of the channel 2. The helical headpiece 5 is configured with at least one projecting helix vane 8, 8.1, the span of which is larger and the width of which is less than the clear span of the opening 3 of the channel 2. The height of the headpiece 5 is moreover smaller than the clear height of the undercut of the channel 2. In order to secure the headpiece 5 of the at least one locking bar 15, 15.1 of the locking element 12 that engages in the undercut of the channel 2, this interacts with at least one projecting helical vane 8, 8.1.

### CROSS REFERENCE APPLICATIONS

This application claims the benefit of German Application No Application No. 20 2010 008 312.5 filed. Aug. 19, 2010, which is incorporated herein by reference for all purposes.

### BACKGROUND

The invention relates to a rail channel connector. The rail channel connector has a connector with a headpiece configured to engage into an undercut channel of a rail and for introducing the headpiece into the undercut of the channel through the channel opening running the longitudinally along the rail. The connector has a means for attaching an item to the rail channel connector and a locking element with at least one locking bar provided for engaging into the channel to secure the headpiece inserted into the undercut of the channel.

The connectors are used for attaching of items onto carrier rails, such as are used for exhibition stand construction, store fittings, or in stage engineering. These carrier rails have at least one channel running the longitudinally along the rail. Items to be fastened to the rail are anchored into the channel. Multiple carrier rails are often connected to each other as structural entities. The rail channel connectors are used as coupling members and as attachment points for attaching items to the carrier rail. The rail channel connectors are often used for mounting items to the outside of such rail. Lights, supports, items or pictures are a few of the items that are connected to the rail channel connectors.

These rail channel connectors have a headpiece designed to engage into the undercut channel of the carrier rail. The rail channel connectors also have a neck section formed onto the headpiece. The width of the neck section is narrower than the headpiece. The headpiece has width that essentially corresponds to the inside width of the channel opening. Formed onto the neck section is a shaft that has one or several means for attaching an item. One example of such a means is external threading, so that the shaft is designed as a threaded rod. An item to be connected to the rail by the rail channel connector will then be mounted on this threaded rod.

In addition the above rail channel connectors, also known are rail channel connectors that engage into only one half the side of the undercut channel of the rail. These rail channel connectors can be inserted into the undercut channel of such rail even after this has been connected with other rails or other components and the front of the channels are no longer accessible. Such rail channel connectors are also referred to as T-head bolts because of their oblong headpiece. T-head bolts have a headpiece that is formed onto one side of the neck section and are at an angle with respect to the longitudinal axis of the shaft. The longitudinal axis of the headpiece itself runs parallel to the longitudinal axis of the shaft. Such known rail channel connector have a hook-like appearance. The angular headpiece engages into one of the two undercut sides of the channel. Therefore, these headpieces engage only one half the side of the undercut provided by the channel. The maximum width of the headpiece and the neck section formed onto it does not exceed the inside width of the channel of the rail into which such rail channel connector is to be inserted.

The headpiece is inserted by means of a swiveling motion, during which the side face of the headpiece is initially inserted into the channel opening. The rail channel connector is subsequently put upright relative to the surface of the rail, until its shaft is aligned roughly rectangular to the surface of the rail. A locking element is used to secure such rail channel connector into the position into which it has been inserted in the channel. The locking element is a nut that is screwed onto the shaft which has been equipped with a thread. By using a flat washer in-between when the nut is screwed onto the shaft toward the neck section, swiveling the rail channel connector in the opposite direction of the swiveling used to insert it is prevented. In order to ensure this, such rail channel connectors can be used only for such rails which have a level channel boundary surface on the outside. Using such rail channel connectors with an undercut channel that has circular rails is thus not possible, in principle.

A disadvantage of the foregoing prior is that items can typically be connected only onto the shaft of the rail channel connector when this is firmly engaged into the channel of a carrier rail. This is especially applicable when an item is to be connected with several rail channel connectors onto a rail or onto a construction that is made up from several rails, such as a frame. A preassembly of the rail channel connector onto the item to be mounted is not possible, because the swiveling motion necessary for inserting the headpieces into the one or the several channels of the one or the several carrier rails can then no longer be performed.

The foregoing example of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tool and methods which are meant to be exemplary and illustrative, not limiting in scope. In various embodiments, one or more of the above described problems have been reduced or eliminated, while other embodiments are directed to other improvements.

On aspect of the current disclosure is to improve a rail channel connector mentioned at the outset such that the connector can be mounted in a carrier rail even when several rail channel connectors have been connected to the item to be assembled by means of preassembly.

In one embodiment the rail channel connector has helix shaped headpiece with at least one projecting helical vane, the span of which is larger and the thickness of which is smaller than the clear span of the opening of the channel and the height of which is smaller than the clear height of the undercut of the channel. The headpiece of the at least one locking bar of the locking element that engages into the undercut of the channel interacts with at least one projecting helical vane for securing the headpiece.

In this rail channel connector, the headpiece is designed as a helix with two helical vanes that are diametrically reciprocally opposed. The span of the helix with at least one vane is larger than the clear span of the opening of the channel. However, the thickness of the helix is smaller than the clear span of the channel opening. Consequently, the helix can be easily introduced through the channel opening into the undercut of the channel. Because the headpiece is a helix, it can be introduced into the undercut of the channel by a rotary motion and not by a tilting motion, in contrast to the prior art. In this context, it is provided that the helix is designed such that the rotary motion for introducing the headpiece into the undercut of the channel is performed about the axis of the shaft of the rail channel connector. It is therefore easily possible to attach items onto a carrier rail on which several rail channel connectors have already preassembled. It must merely be ensured that the rail channel connectors connected to the item to be mounted can be rotated about the axis of the shaft. The top side of the vane/s of the headpiece is preferably adapted to the inside contour of the channel.

It is not required that the rail channel connector be actively rotated to introduce the headpiece. This is because a rotary motion is produced as a result of the design of the helix when the base of it is inserted into the channel opening and a solely axial force is applied to the rail channel connector. The headpiece automatically rotates into the undercut of the channel of the carrier rail when such force is applied.

At least the one locking bar of the locking element serves to secure the headpiece engaged into the undercut of the channel. The locking bar interacts with the projecting helical vane acting like a stop. The locking bar of the locking element acting together with the helical vane blocks the counter rotation of the headpiece and the rail channel connector is therefore connected captively to the carrier rail after the locking element has been fixed.

Another advantage of this rail channel connector is that it can be connected to rails with an undercut channel of which the external circumferential surface can have virtually any geometry.

The locking element of this rail channel connector will suitably be designed the same as the one which is described in context with a rail channel connector in DE 20 2009 002 005 U1 by the same applicant, which is incorporated herein by reference for all purposes. By making this explicit reference to DE 20 2009 002 005 U1, the explanations given therein with reference to the locking element with its at least one locking bar and the interaction with the headpiece for locking same within the undercut of a channel of a carrier rail is also made a subject matter of these explanations.

In a disclosed embodiment it is provided that the span of the helical vanes is a little larger than the clear width of the undercut of the channel of the carrier rail. In this manner, the screwing-in movement of the helical headpiece is limited.

According to one embodiment, the locking bar/s of the locking element and/or the seating surfaces of the headpiece that are interacting with the locking bar/s are inclined such that the introduction of the locking bar/s through the channel opening acts like a wedge on the helix and this jams within the undercut because of the oversize of the vane span in relation to the clear width of the channel.

According to an embodiment of the invention, the headpiece is formed onto a shaft which projects beyond the channel of the carrier rail. This can be designed as a threaded shaft and serves for fixing the locking element and for attaching an item onto the rail channel connector. In this embodiment, the rail channel connector is fixed and therefore attached to the carrier rail by means of a nut. This acts on the locking element which supports itself on the outside of the rail. The headpiece forms the abutment for supporting the locking element on the outside of the rail so that the rail channel connector is kept braced in this manner on the areas of the carrier rail bordering the channel.

According to an alternative embodiment, instead of using a nut which is threaded onto a threaded shaft, a bracing of the same type can be performed with the aid of an eccentric or a safety wedge. It should be readily understood that the shaft formed onto the headpiece then does not have to be designed as a threaded shaft. The shaft can nevertheless have an external end section with a thread, which threaded end section then serves as a means for attaching one or several items onto the rail channel connector.

In addition to an embodiment in which such rail channel connector have a means for attaching items, such as a threaded shaft or suchlike, in a further embodiment the rail channel connector is an integral constituent part of a functional component. In this instance, this may involve a bracket, a plate, a hinge, a hook, or suchlike, for example.

With the previously described design it is possible to use not only the carrier rail as a carrier for further items, but instead use the rail channel connectors in order to attach the carrier rail itself to another item and/or keep it on same.

Moreover it is possible to engage one or several further items in the connection of rail channel connector and rail and in this manner attach and/or connect these to the rail. If these are engaged between the carrier rail and the locking element, it should be readily understood that such items which are to be attached to the carrier rail have an elongated hole through which the locking bar/s of the locking element can reach in order to be able to engage into the channel of the carrier rail.

In addition to the exemplary aspects and embodiments described above, further aspects and embodiments will become apparent by reference to the accompanying drawings forming a part of this specification wherein like reference characters designate corresponding parts in the several views.

### BRIEF DESCRIPTION OF THE DRAWINGS

FIG. 1a, 1b are a perspective view (FIG. 1a) and a side elevation (FIG. 1b) of a rail channel connector attached to a carrier rail.

FIG. 2a, 2b are exploded views of the rail channel connectors of FIG. 1, viewed from two different directions.

FIG. 3a, 3b are explodes view representing a first step of assembly for attaching the rail channel connector onto the carrier rail.

FIG. 4a, 4b show the next step of the attachment procedure of the rail channel connector of FIGS. 3a, 3b.

FIG. 5a, 5b show the next step of the attachment procedure of the rail channel connector of FIGS. 4a, 4b.

FIG. 6a, 6b show the next step of the attachment procedure of the rail channel connector of FIGS. 5a, 5b.

FIG. 7a, 7b show the rail channel connector with its headpiece introduced into the undercut of the carrier rail prior to the connection of a locking element.

FIG. 8 is a perspective illustration of the rail channel connector fixed in the channel of the carrier rail, shown without the carrier rail.

FIG. 9 is a perspective illustration of the rail channel connector fixed in the channel of the carrier rail, shown with the carrier rail.

FIG. 10 is the rail channel connector of FIG. 9 inserted into a carrier rail.

FIG. 11 is a perspective illustration of a further rail channel connector.

FIG. 12 is the rail channel connector of FIG. 11 inserted into a carrier rail.

FIGS. 13a-13c are further embodiments of rail channel connector.

FIG. 14 is an exemplary arrangement of a carrier rail with slats connected to it by means of rail channel connectors.

Before explaining the disclosed embodiment of the present invention in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION OF THE DRAWINGS

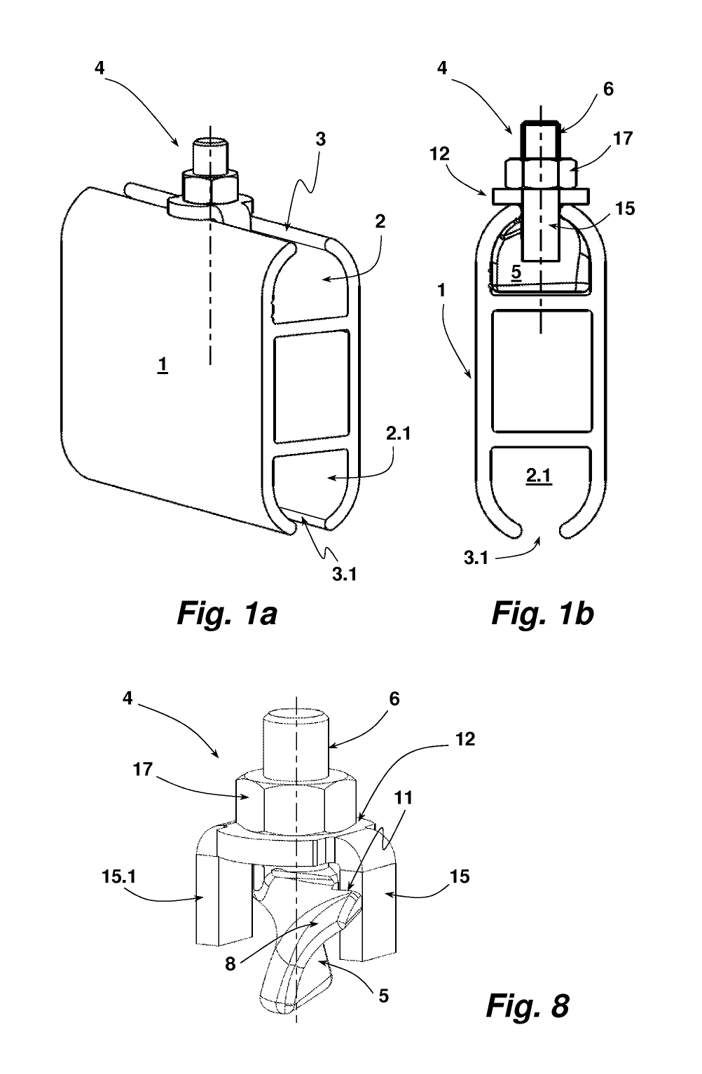

FIGS. 1a, 1b illustrate a carrier rail 1 which has two adjacent reciprocally arranged channels 2, 2.1. The channels 2, 2.1 are undercut channels which follow the longitudinal direction of the carrier rail 1, as can be seen from the Figure. The channels 2, 2.1 each have a channel opening 3, 3.1 which follows the longitudinal direction of the carrier rail 1. The width of the channel openings 3, 3.1 is markedly less than the inner width of the respective channel 2, 2.1. The carrier rail 1 is part of a rail construction which is not otherwise closer detailed, which is formed from several rails onto which an item is to be attached. In the illustrated embodiment, the channel 2 serves as the mounting and/or connection channel for attaching rail channel connectors. As an example, FIG. 1 illustrates a rail channel connector 4 attached to the carrier rail 1. The rail channel connector 4 serves as the attachment point for attaching one or several items.

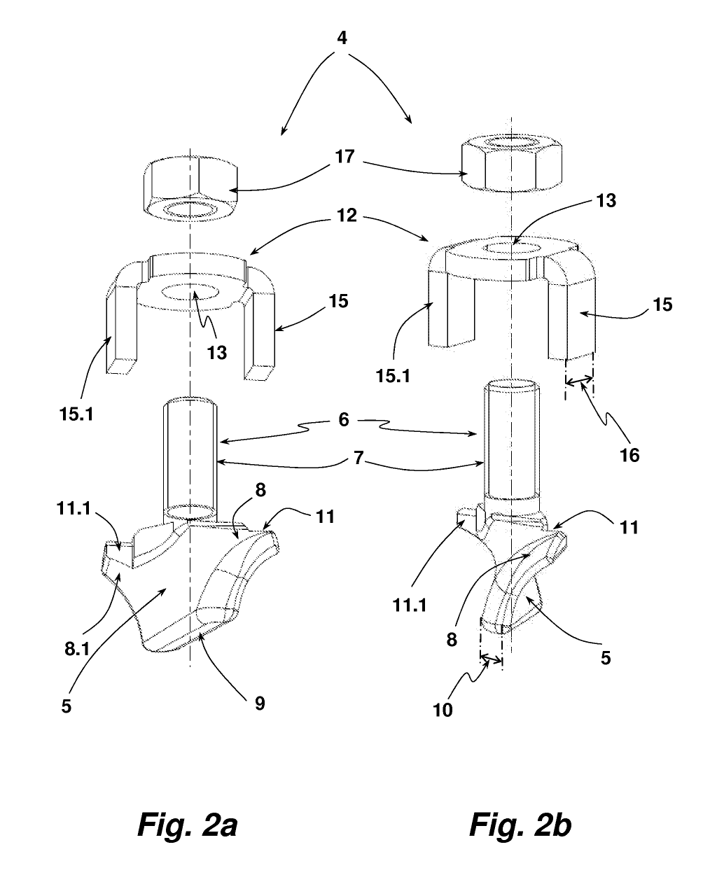

The details of the rail channel connector 4 can be better seen in the perspective views of FIGS. 2a, 2b. The rail channel connector 4 includes a helix shaped headpiece 5. A shaft 6 is formed onto the headpiece 5, where the shaft has an external thread 7 in the illustrated embodiment. The shaft 7 serves as the mounting element for attaching an item.

The helix shaped headpiece 5 has two helical vanes 8, 8.1 in the illustrated embodiment. The helical vanes 8, 8.1 are arranged diametrically opposite each other with reference to the longitudinal axis of the rail channel connector 4. Starting out from the base 9 of the headpiece 5, the gradient in the helical vanes 8, 8.1 decreases in the direction of the terminus of the headpiece 5 where it meets the shaft. The helix itself extends across roughly 80 degrees. The thickness 10 of the headpiece 5 is less than the width of the channel opening 3. This is necessary so that the headpiece 5 can be turned-in through the channel opening 3 into the undercut of the channel 2. The span of the headpiece 5—, the distance between the radial external terminuses of the helical vanes 8, 8.1.—, is larger than the width of the channel opening 3, and in the embodiments represented is also larger than the clear width of the undercut of the channel 2. The thickness 10 remains uniform across the axial extension of the helix from the base 9 up to the upper terminus of same.

The two helical vanes 8, 8.1, each have a seating surface 11, 11.1 near their upper terminus. If the headpiece 5 is turned into the channel 2, then the seating surfaces 11, 11.1 are approximately aligned with the boundaries of the channel opening 3 on the side of the rail.

The rail channel connector 4 also includes a locking element 12. This consists of a disk 14 with a central opening 13 and two diametrical opposed locking bars 15, 15.1. The locking bars 15, 15.1 are formed from the plane of the disk 14 and are bent in the direction of the headpiece 5. The width 16 of the locking bars 15, 15.1 of the locking element 12 is less than the width of the channel opening 3 by the clearance necessary for mounting the locking element 12. The distance of the locking bars 15, 15.1 of the locking element 12 is configured such that each locking bar 15 and/or 15.1 rests with its narrow sides against the seating surface 11 and/or 11.1 of the helical headpiece 5 and/or can be made to rest against it. The locking element 12 is fixed with its external thread 7 on the shaft 6 by means of a nut 17.

Since the locking element 12 is secured against rotation by engagement of the locking bars 15, 15.1 into the channel opening 3, and as the locking bars 15, 15.1 are aligned with reference to a rotational movement of the headpiece 5 in the track of the seating surfaces 11, 11.1, they form a seat for the headpiece 5 and are thus effectively secured against rotation so that when the locking element 12 is fixed. Therefore the headpiece can no longer be turned out of the channel 2 once the locking element is in place.

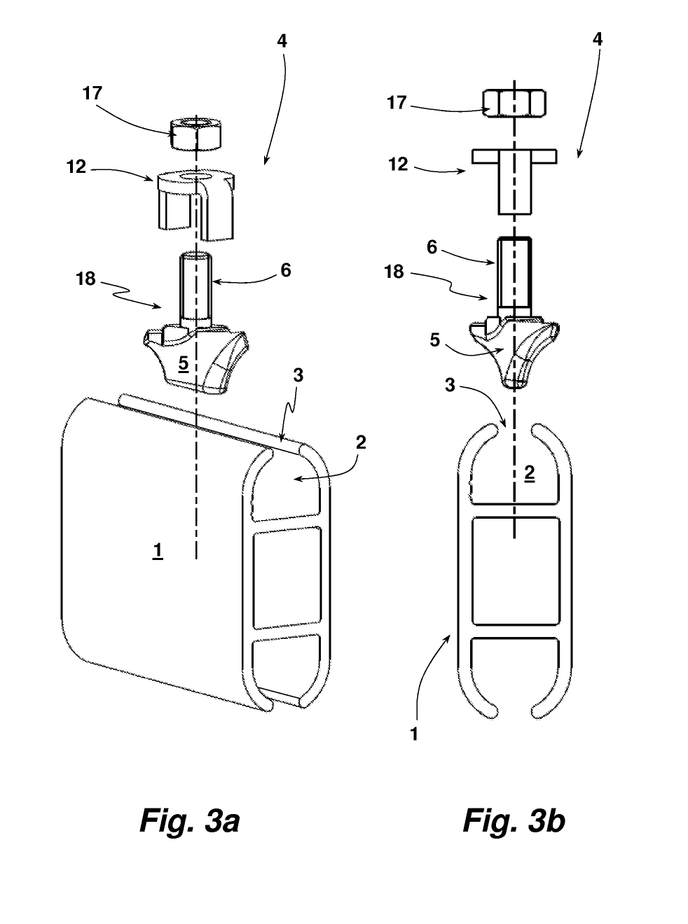

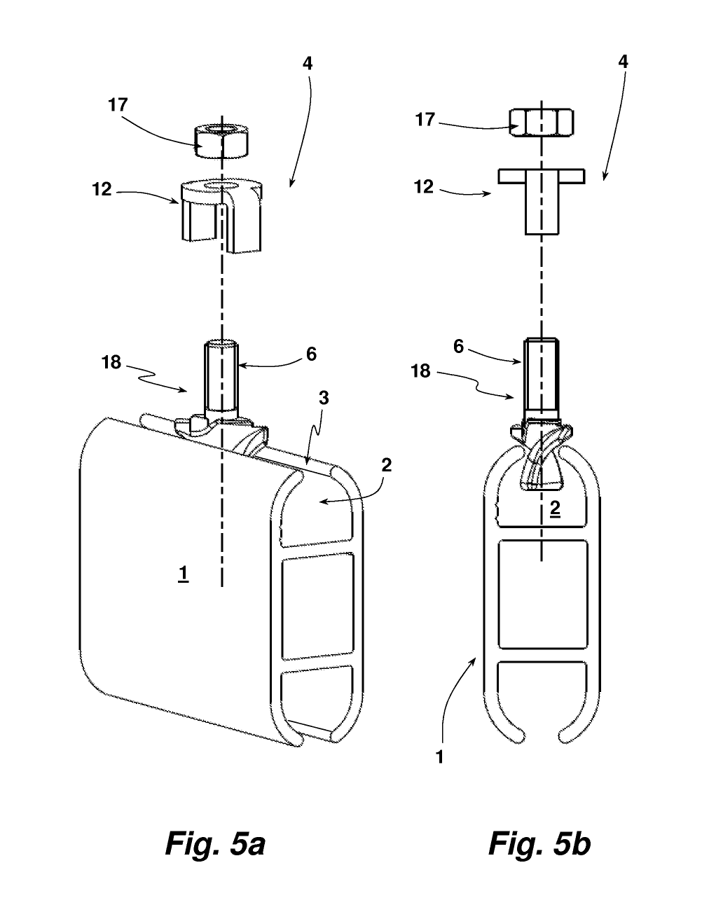

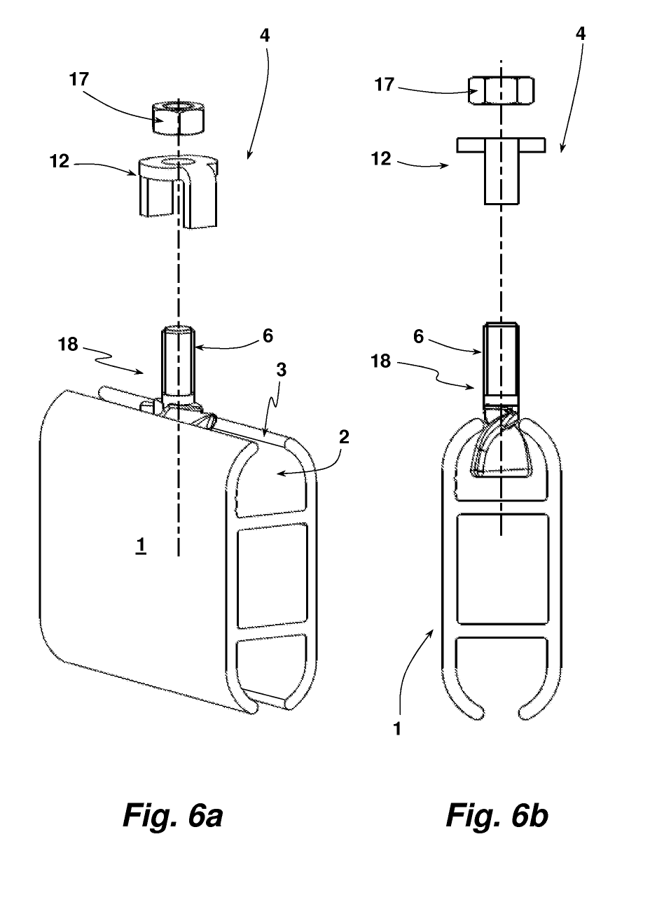

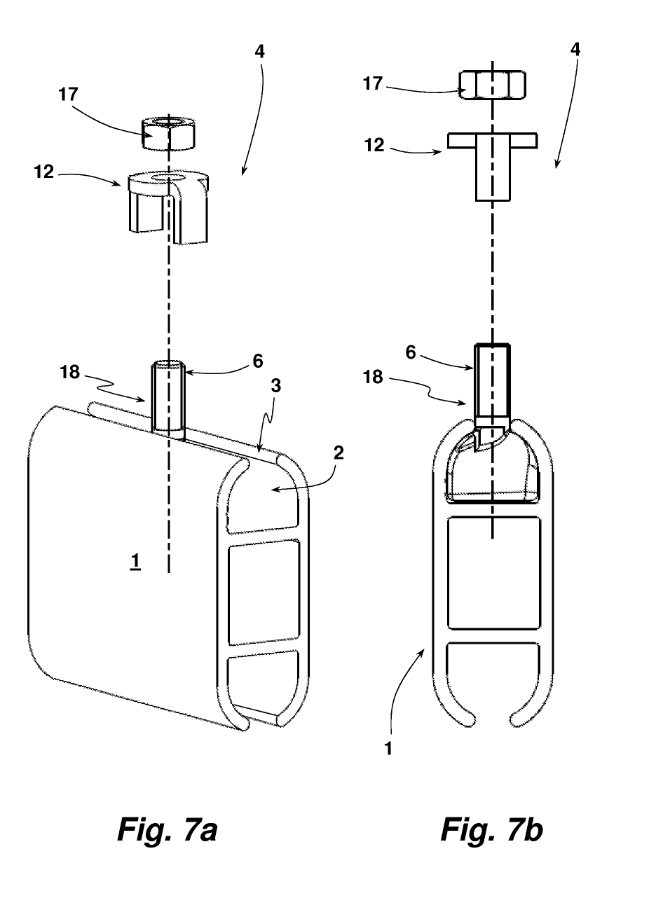

A starting position for attaching the rail channel connector 4 onto the carrier rail 1 is shown in FIGS. 3a, 3b. Initially the connector 18, which consists of the helical headpiece 5 and the shaft 6, is introduced through the channel opening 3 into the channel 2. In a first step the connector 18 with the base 9 of the headpiece 5 is inserted into the channel opening 3. By rotating the connector, or even just by applying an axial force it, the helical headpiece 5 is introduced through the channel opening 3 into the undercut of the channel 2. The connector 18 rotates clockwise about the axis of the shaft 6 in the depicted embodiment for this purpose. The rotation of the headpiece 5 during the assembly procedure for introducing same into the undercut of the channel 2 is shown the illustrations of FIGS. 5a, 5b, 6a, 6b and 7a, 7b. Starting with the illustration in FIGS. 3a, 3b, the connector 18 has been rotated by approximately 80 degrees in order to attain its final position shown in FIGS. 7a, 7b.

As the span of the head piece 5 is larger than the clear inside width of the channel 2, the radial exterior sides of the helical vanes 8 in the position of the connector 18 shown in FIGS. 7a and 7b act against the interior wall of the channel 2. FIG. 7b shows that the top side of the helical vanes 8, 8.1 is shaped to the inside contour of the channel 2. A transfer of forces is therefore performed by the rail channel connector 4 into the carrier rail 1 by at least one line contact. Therefore, the connection points can be loaded with high forces.

To secure the connector 18 in its position shown in FIGS. 7a, 7b, the locking element 12 with its locking bars 15, 15.1 is fitted onto the shaft 6 of the connector 18 and is shifted in the direction of the headpiece 5, so that the locking bars 15, 15.1 reach through the channel opening 3. The locking element 12 is fixed by screwing the nut 17 onto the external thread 7 of the shaft 6. The rail channel connector 4 which is attached to the carrier rail 1 in this form is shown in FIGS. 1a, 1b. FIG. 1b shows the seating arrangement between the locking bar 15 of the locking element 12 and the seating surface 11 of the headpiece 5.

FIG. 8 shows the arrangement between the connector 18 and the locking element 12 and/or its locking bars 15, 15.1, when the rail channel connector 4 is attached to the carrier rail 1 with the carrier rail 1 not shown.

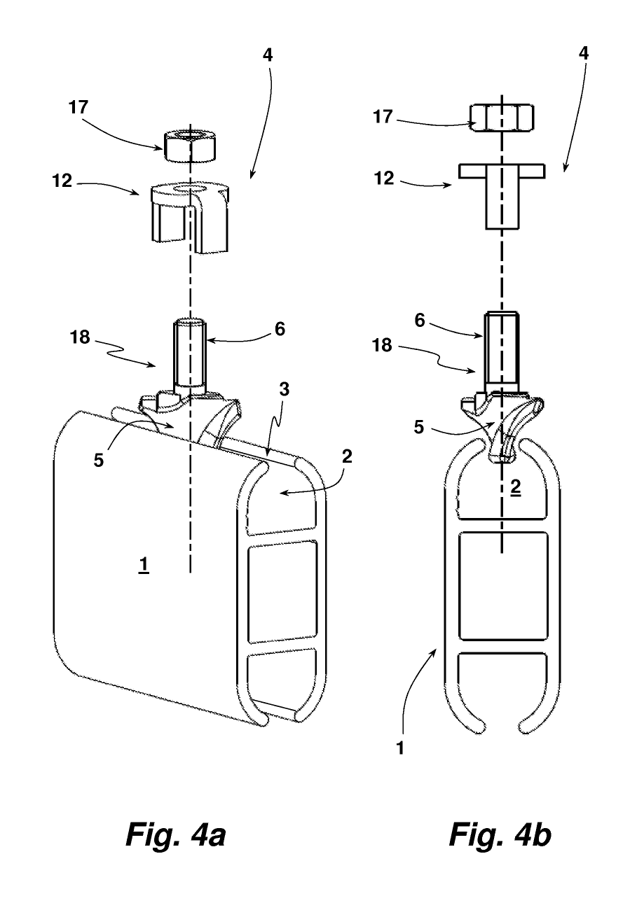

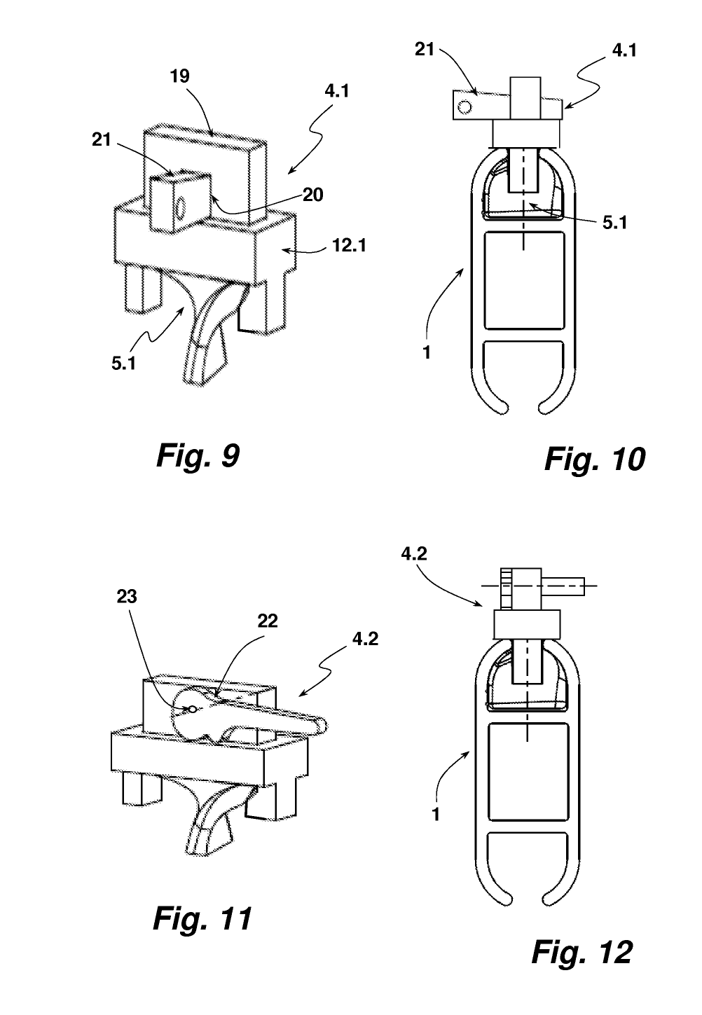

FIG. 9 shows a schematic view of a second embodiment of a rail channel connector 4.1. In principle, this is structured the same as the rail channel connector 4 of the embodiment of the previous Figures. The difference to the rail channel connector 4 is that a stem 19 is formed onto the headpiece 5.1 with the rail channel connector 4.1. The stem 19 serves as a means for attaching an item onto the rail channel connector or as a connecting link for such means. The stem 19 has an opening 20. In order to brace the rail channel connector 4.1 onto a carrier rail, a wedge 21 is used, which is pushed through the opening 20 of the rail channel connector 4.1 and is fixed therein, namely by a locking element 12.1 inbetween. The locking element 12.1 has two tilted locking bars which abut the helical vanes of the head piece 5.1, the same as the locking element 12 as is described in connection with the embodiments of FIGS. 1 to 8.

FIG. 10, in a side elevation that corresponds to the one of FIG. 1b, shows the rail channel connector 4.1 attached onto the carrier rail 1. The headpiece 5.1 supports itself with its top side on the inside wall of the channel. The lower side of the locking element 12.1 acts on the outside of the carrier rail 1. The locking bars of same reach through the channel opening. Because of the wedge 21 which reaches through the opening 20, the rail channel connector 4.1 is securely attached onto the carrier rail 1.

FIG. 11 shows a further rail channel connector 4.2 in a perspective view. This is constructed similarly as the rail channel connector 4.1. In order to brace this embodiment an eccentric lever 22 is used. FIG. 11 shows the eccentric lever 22 in its position where it braces the rail channel connector 1 on a carrier rail. The pivot axis 23 of the eccentric lever 22 is entered schematically in FIG. 11. FIG. 12 shows the rail channel connector 4.2 attached onto the carrier rail 1.

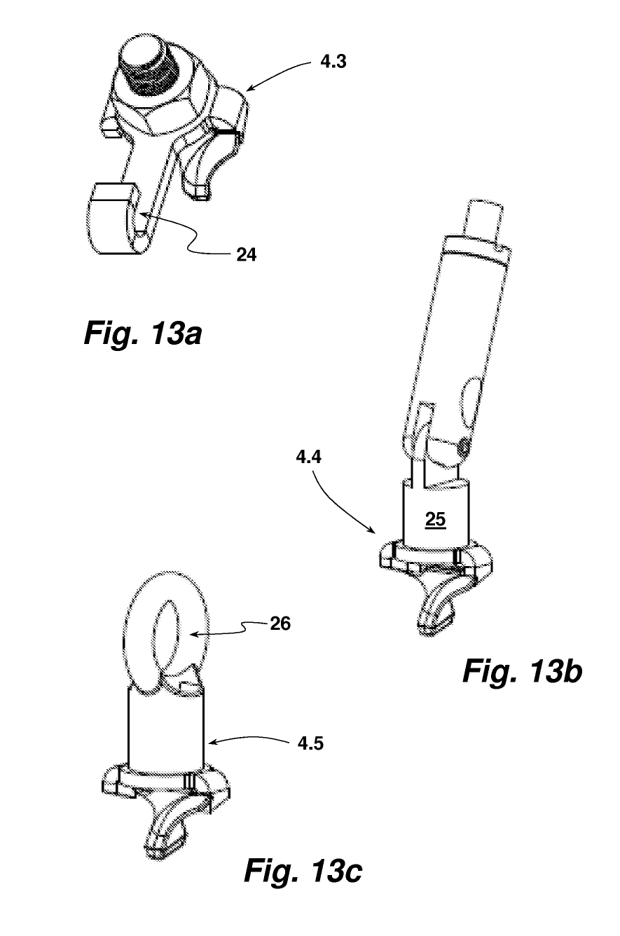

Further rail channel connectors 4.3, 4.4, 4.5, are shown as exemplary embodiments in FIGS. 13a to 13c, in which the rail channel connector 4.3, 4.4 and/or 4.5 is an integral constituent of a functional component. The rail channel connectors 4.3, 4.4 and 4.5 are structured in principle the same as the rail channel connector 4. The respective headpiece therefore has a threaded shaft onto which a nut can be screwed for fixing the locking element. A hook 24 is formed onto the locking element on the rail channel connector 4.3 of FIG. 13a. On the rail channel adapter 4.4 of FIG. 13b the nut for securing the locking elements is designed as the first member 25 of a pivot joint. This first member 25 has an inside thread which is screwed onto the threaded shaft at the headpiece and braces the locking element together with the carrier rail. The section of the nut that can be screwed onto the threaded shaft is an eyelet 26 on rail channel connector 4.5 shown in FIG. 13c. These embodiments clearly show that to design a rail channel adapter as an integral constituent of a functional component, the component can be part of the locking element or part of the bracing element, in the present case, a nut. Furthermore it is possible to use the part formed onto the head piece, which in the illustrated embodiment is designed as a shaft or a stem, in order to form onto it a functional item and in this manner make this into an integral constituent of the rail channel connector.

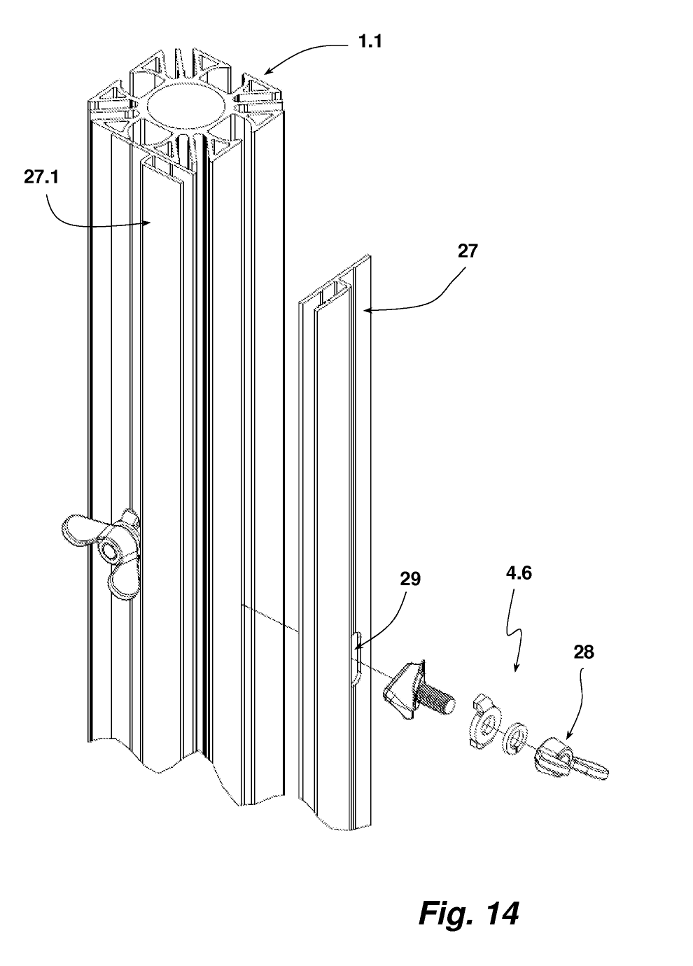

FIG. 14 shows the carrier rail 1.1 with two slats 27, 27.1 connected. The slat 27 is shown in the form of an exploded view in relation to the carrier rail 1.1. With the rail channel connector 4.6 for connecting the slat 27 onto the carrier rail 1.1, a rail channel connector 4.6 is used, which in principle is structured same as the rail channel connector 4 of FIGS. 1 to 8. The rail channel connector 4.6 is fixed onto the carrier rail 1.1 with a wing nut 28. The slat 27 has an elongated hole 29 which the threaded shaft of the rail channel connector reaches through. The elongated hole 29 also allows the locking bars of the locking element of the rail channel connector 4.6 to pass through. The slat 27.1 is shown in its position attached onto the carrier rail 1.1. Due to the design it is possible to install the rail channel connector 4.6 through the elongated hole 29, so that it does not have to be introduced initially into the channel of the carrier rail 1.1, before the slat 27 or 27.1 is brought close to the carrier rail 1.1. It is therefore possible to keep the slat 27 against the carrier rail 1.1 with the elongated hole 29 aligned with the channel opening to then fix the slat on the carrier rail 1 by means of one or also several rail channel connectors 4.6.

While a number of exemplary aspects and embodiments have been discussed above, those of skill in the art will recognize certain modifications, permutations, additions and sub-combinations therefore. It is therefore intended that the following appended claims hereinafter introduced are interpreted to include all such modifications, permutations, additions and sub-combinations are within their true spirit and scope. Each apparatus embodiment described herein has numerous equivalents.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. The above definitions are provided to clarify their specific use in the context of the invention.

### LIST OF REFERENCE SYMBOLS

1, 1.1 Carrier rail
2, 2.1 Channel
3, 3.1 Channel opening
4, 4.1, 4.2, 4.3, 4.4, 4.5, 4.6 Rail channel connector
5, 5.1 Headpiece
6 Shaft
7 External thread
8, 8.1 Helical vane
9 Base
10 Material thickness
11, 11.1 Seating surface
12, 12.1 Locking element
13 Opening
14 Disk
15, 15.1 Locking bar
16 Width
17 Nut
18 Connector
19 Stem
20 Opening
21 Wedge
22 Eccentric lever
23 Pivot axis
24 Hook
25 Member
26 Eyelet
27, 27.1 Slat
28 Wing nut
29 Elongated hole

I claim:

1. A rail channel connector for use with a carrier rail with a channel opening which follows the longitudinal length of the rail and the channel being undercut, the channel undercut having a height and a width and the channel opening having a width, the rail channel connector comprising:
a helical headpiece configured for engaging into an undercut channel of a rail;
the helical headpiece having at least one projecting helical vane having a span and a thickness and a means for attaching an item onto the rail channel connector;
the span the helical headpiece is greater than and the thickness of which is less than the width of the opening of the channel and the height of which is smaller than the height of the undercut of the channel;
a locking element with at least one locking bar provided for engaging into the channel for securing the helical headpiece when the helical head piece is inserted into the undercut of the channel; and
the at least one locking bar of the locking element interacts with at least one projecting helical vane to secure the helical headpiece engaged into the undercut of the channels.

2. The rail channel connector of claim 1 wherein the top side of the helical vane of the headpiece has been adapted to an inside contour of the channel.

3. The rail channel connector of claim 1 wherein the span of the headpiece in the area of its base is smaller than in the area of its upper terminus.

4. The rail channel connector of claim 1 wherein the thickness of the helical headpiece is uniform or almost uniform across the extent of the helical vanes.

5. The rail channel connector of claim 1 wherein the helical headpiece has two reciprocally opposite vanes with reference to a shaft.

6. The rail channel connector of claim 1 wherein the at least one locking bar of the locking element is designed as a member that can be inserted into the channel and is configured with a width that corresponds essentially to the width of the inside width of the opening of the channel.

7. The rail channel connector of claim 1 wherein the locking element has one disk that can be slipped onto a shaft with at least one angled member as a locking bar extending therefrom.

8. The rail channel connector of claim 7 wherein the disk has two locking bars extending in opposite directions from the disk.

9. The rail channel connector of claim 7 wherein the shaft of the rail channel connector is a threaded shaft and that the disk is held by means of a nut seated on the threaded shaft and that the shaft is also a means for attaching an item onto the rail channel connector.

10. The rail channel connector of claim 8 wherein the shaft of the rail channel connector is a threaded shaft and that the disk is held by means of a nut seated on the threaded shaft and that the shaft is also a means for attaching an item onto the rail channel connector.

11. The rail channel connector of claim 7 wherein the locking element is held in its position to secure the headpiece by means of an eccentric or a locking wedge.

12. The rail channel connector of claim 8 wherein the locking element is held in its position to secure the headpiece by means of an eccentric or a locking wedge.

13. The rail channel connector of claim 1 wherein the rail channel connector is part of a functional component.

14. The rail channel connector of claim 2 wherein the rail channel connector is part of a functional component.

15. The rail channel connector of claim 3 wherein the rail channel connector is part of a functional component.

16. The rail channel connector of claim 4 wherein the rail channel connector is part of a functional component.
